(19) United States
(12) Patent Application Publication
(10) Pub. No.: US 2006/0107325 A1
(43) Pub. Date: May 18, 2006

(54) Method for creating and processing data streams that contain encrypted and decrypted data

(76) Inventors: Egil Kanestrom, Mandal (NO); Pal Berg, Mandal (NO)

Correspondence Address: William B Patterson;Moser Patterson & Sheridan, Suite 1500, 3040 Post Oak Boulevard, Houston, TX, 77056, US

(21) Appl. No.: 10/524,450

(22) PCT Filed: Aug. 13, 2003
(86) PCT No.: PCT/NO03/00275

§ 371 Date: Sep. 27, 2005

(30) Foreign Application Priority Data
Aug. 14, 2002 (NO) 20023860

(51) Int. Cl. H04N 7/16

(52) U.S. Cl. 726/26

(57) ABSTRACT

A client filter is provided for filtering data to and from network servers. The filter has connection with a token that holds licenses which include cryptographic keys. Any data that is downloaded or uploaded over a network goes through the filter before it is presented for the user or a server. The filter identifies tags in the data and uses information in the licenses to determine the data that will pass through the filter. For uploading, the filter encrypts the tagged data with a chosen license. For download, the tagged data is decrypted if a proper license is found and the data is presented for the user.

### BACKGROUND OF THE INVENTION

The present invention describes a method for protection and publication of selected parts of information between peer users in a computer system.

Current computer environments typically allow access to various networks with a wide range of services and service providers, where information, data and software are exchanged. To protect the data being processed and exchanged, different security enforcing mechanisms such as authentication, access control and encryption, are implemented. For example, access to a resource, e.g., a server, may be controlled by password-based authentication. A data file may be encrypted at the local workstation and stored on the local hard disk, the local network file server or uploaded (published) to a remote server on the Internet. Possibly more than one user may be able to retrieve the encrypted file, but only authorized users who possess the decryption key are able to decrypt and thus view the file. This scenario is illustrated in FIG. 1 where data is encrypted and made available on a server. A local client (1) can encrypt (80) data (10) and make the encrypted data (20) available on a server (2). A client can then obtain the encrypted data (20), decrypt it (90) and get the plain data (11).

A problem with this traditional approach is to allow for co-located data items with different security requirements to be shared among the respective authorized user groups. In a multi-level security context, this problem is referred to as “system-high”, where data tends to end up with a higher security level than strictly required. For example, in a two-level security system, access to a resource is denied to all users who are not able to provide authentication information. If only parts of the content of a file is of sensitive nature, then, because the entire file was encrypted, ordinary users who do not possess the decryption key are no longer able to access the non-sensitive parts of the file.

### BRIEF SUMMARY OF THE INVENTION

A first objective of the present invention is to provide a method that allows relevant parts of data to be shared, while at the same time protects those other parts of the data which need protection. Information needs to be shared, while at the same time be protected. This also gives the possibility for data to be available at several different levels in a multi level security system. A second objective of the present invention is to provide a method to authorize and de-authorize access to data that allows for easy management of user authorization and de-authorization.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings an embodiment that is presently preferred. It should be understood, however, that the invention is not limited to the precise arrangements and instrumentalities shown. In the drawings:

FIG. 1 shows distribution of confidential data in accordance with the prior art.

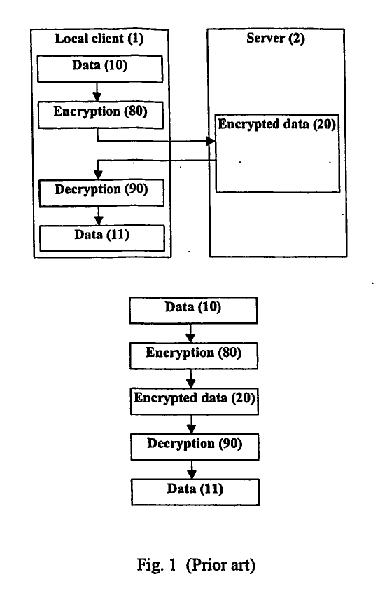

FIG. 2 illustrates the concept of protecting parts of data in a first embodiment of the present invention.

FIG. 3 illustrates the concept of protecting parts of data in a second embodiment of the present invention, with inclusion of an external secure device and where the encrypted data is distributed via a server.

FIG. 4 is a flowchart of the data protection process.

FIG. 5 is a flowchart of the data presentation process.

FIG. 6 is a summary flowchart of entire data flow.

FIG. 7 is a flowchart describing the data flow when access control rights are employed.

FIG. 8 shows the selection of parts of information to be protected in a html editor.

FIG. 9 shows the pop-up window that allows a user to choose a particular license that will be used for encryption.

FIG. 10 shows the result after a part of the code is protected.

FIG. 11 illustrates the view in a browser window when the data is decrypted and presented as ordinary html code.

### DETAILED DESCRIPTION OF THE INVENTION

Certain terminology is used herein for convenience only and is not to be taken as a limitation on the present invention. In the drawings, the same reference letters are employed for designating the same elements throughout the several figures.

1. Definitions/Notes

Rendition—one example is an electronic publication file, such as an HTML page.

Data editor application or editor—a computer application that is used in editing and preparing data

Data presentation application or reader—a computer application that is used in presenting (viewing, browsing, playing, execution and others) data for users of the application

License—may include (1) identification number, (2) cryptographic information, (3) access control rights. A license can be a password-based encryption key with no other associated attributes or IDs.

Data—data/information which has some kind of structure or syntax when it is presented to the user, and which is used to store information (that might be compressed), such as text documents, images, sound, video, software applications and other intellectual property data.

Token—smart card or the like with processing power and the ability to store information. The token can be a software token, i.e., a token stored on a hard-drive of a personal computer.

The present invention is used as a filter in different applications where data is edited and presented. This section provides a detailed discussion of various parts of the invention. This discussion will be divided into four parts. The first part considers the contents of a license and specifies the requirements when licenses are stored on tokens. The second part treats the installation of the filter. The third part discusses the preparation of data to be presented on an Internet server, and the fourth part discusses the presentation of the data for a user. At the end of the fourth part, an example of the security filter in html coding is provided.

A collection of a cryptographic key and method for encryption, together with some other attributes, is called a license. Each license is identified with an identification number. Each license with a particular identification number has the same cryptographic information. In addition to cryptographic keys, a license may contain access rights attributes and other constraints like time and number limitations.

The token in the present invention is a medium for storing cryptographic information. If the token is a smart card, then it must be used in a smart card reader which is connected to a user's PC. The token is constructed with a microprocessor, memory, I/O interface, and sometimes a cryptographic coprocessor. The token in the present invention can be either a token with memory only, or a token suitable for processing streams of data. Present off-the-shelves tokens have a low bandwidth which require complicated calculations like encryption and decryption to take place on the PC connected to the token. State-of-the-art tokens contain USB controllers which give a higher bandwidth. The present invention is not limited to using a special token, and thus the complicated calculations may take place either on the PC or the token. The token can also be data stored on the PC, i.e., a software token.

The installed filter includes an interface which is accessible to an editor used for preparing the data to be shared. The filter can be accessible from the editor by the use of add-ins in menus, hotkeys, icons in toolbars or the like. The same installation can be used at the reader's side, but here the access can be more or less automatic from the data being viewed. For Internet browsers, the filter will typically be installed as a proxy.

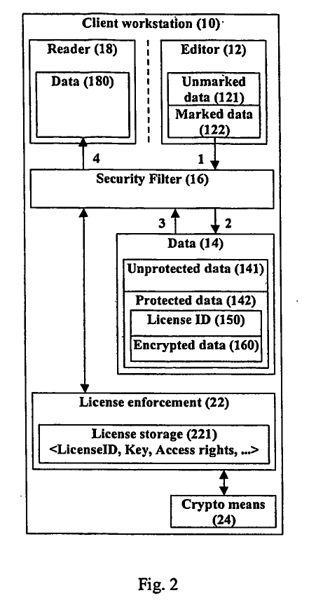

FIG. 2 shows a system and method for protection of a data stream on a stand-alone client workstation (10) with a security filter (16). FIG. 2 further illustrates preparation of data performed in an editor (12) resident on a client (10). The editor (12) has an analog interface to the user, meaning the data is presented in a user readable and understandable form. Some editors have the ability to present the data in a similar way to what the data presentation program or reader does, but this is not a requirement of the present invention. The data can be a programming language (e.g., Java, C/C++, Visual Basic, etc.), text language (e.g., html, Microsoft Word document, xml, etc.), audio (mp3, wav, avi, etc.), video (mpeg, Quicktime, avi, etc.), picture (jpeg, gif, png, etc.) and other formats. The editor in the present invention is must be able to mark data to be protected, resulting in both marked (122) and unmarked (121) data. A typical technique to mark data is to click and hold a mouse button while dragging the cursor over the data as is done in most text editors. When the data is marked, the security filter (16) is invoked and the user has the ability to choose the license (221) that is to be used in protecting the data. This process can be repeated with different parts of the data selected and different licenses chosen. The cryptographic information found in the selected license (221) is then used in the protection of the marked data (122) by crypto means (24). A simpler embodiment exists when a password takes the role of a license. A password would then be similar to cryptographic information, like a secret key, stored in a license. In the simplest embodiment, the data is directly encrypted by the cryptographic information found in the selected license, but more advanced models exist as well, e.g. where the encryption key used to encrypt the data is included in a header of the data, but encrypted with the cryptographic information found in the selected license.

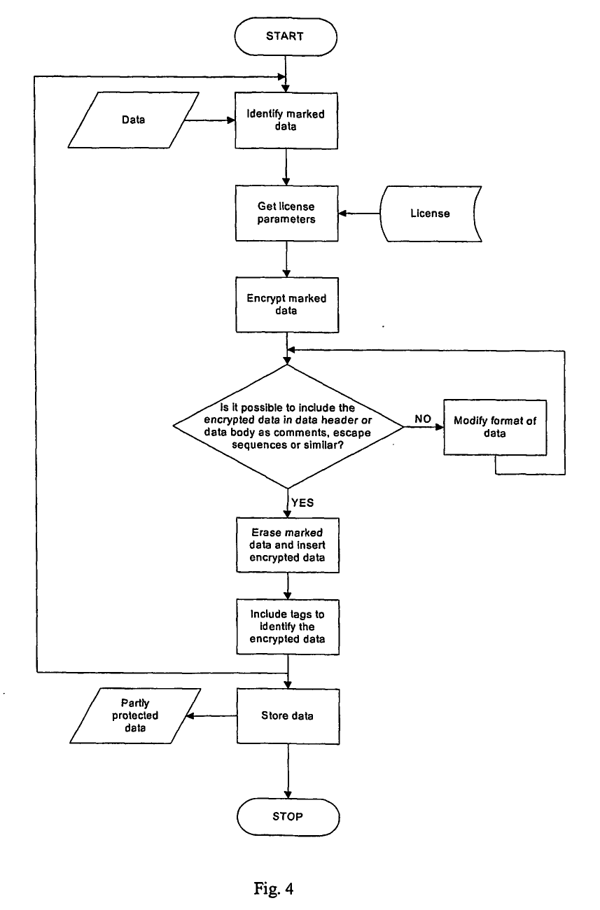

If the presentation format has support for syntax based comments, as in markup languages, the protected data is included in comments fields together with identifying tags for protection applied and license used, and the original marked data is erased. Other embodiments of the format can include headers which can be used for the same purpose. For example, the encrypted data portion may be included within a header of a multimedia data format language, such as an mp3 ID3 header (tag). The protected parts of the data may thus not show up in the editor, depending on whether comments are viewed or not. The data (14) now consists of protected (142) and unprotected (141) parts, where the protected parts include tags (150) that identify the license that was used in the protection, e.g., a license identification number, and encrypted data (160). The encrypted data (160) can hold more information than just the encryption of the marked data (122), such as access control rights (ACR) and other constraints, and message digests of the clear data for integrity protection. This protection process is shown in the flowchart in FIG. 4. In cases with ACR, the protected data and the license must both have ACRs which can be compared. The ACR are most valuable in the use of hardware tokens, like smart cards, where the comparison of license constraints can be performed in a secure environment.

FIG. 2 illustrates the chronological sequence of the data flow as number 1 to 2.

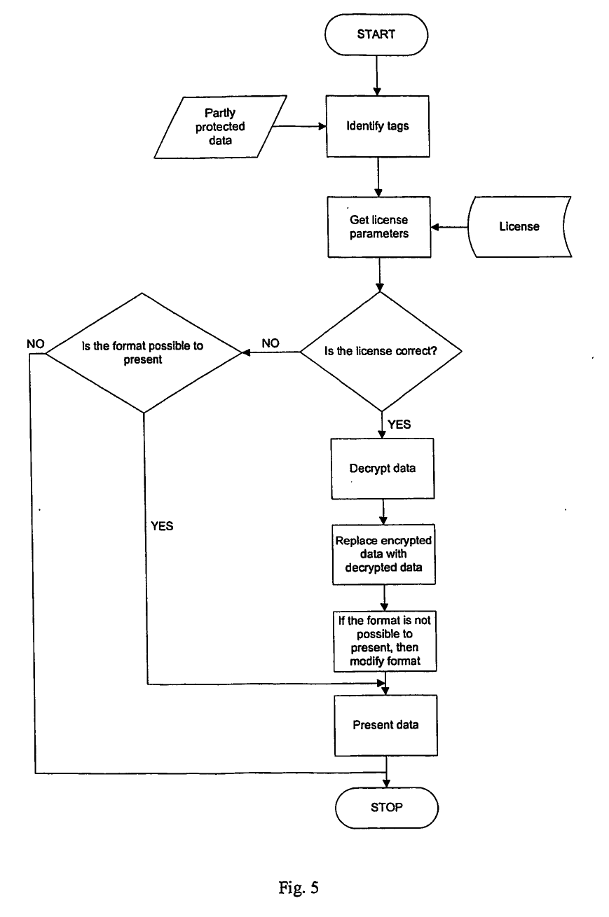

At the other end of the distribution line is the reader (I 8) of the data (14). The reader and editor does not need to be on the same client. If the security filter (16) exists at the client, the data (14) is streamed through the security filter (16) before it is presented to the user. If the license information (150), including possible constraints, found in the protected data (142) by the security filter (16) and the license enforcements (22) invoked by the information in the stored license (221) give the user a legal right to unprotect the encrypted part (160) of the protected data (142), then the data is decrypted. If not, then the data may not be presented, depending of the format of the data. If the encrypted data (160) includes message digests, this can also be verified as legal, i.e., the data has not been altered after the protection took place, before the date is presented. FIG. 2 illustrates the chronological sequence of the data flow as number 3 to 4. FIG. 5 shows a flowchart of the data flow of the presentation process.

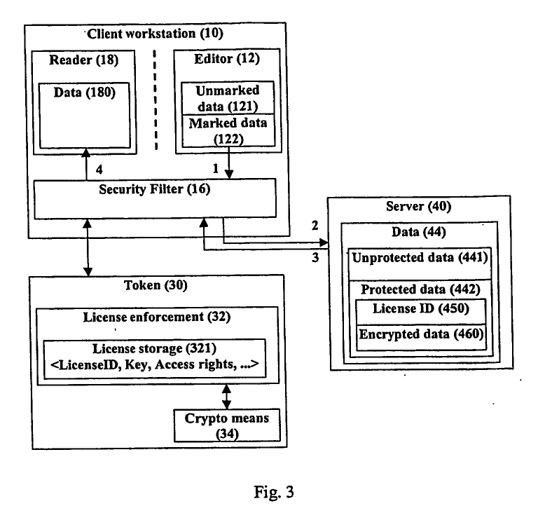

FIG. 3 illustrates an alternative embodiment using a token (30) and a network server (40), where the client (10) is the same as in FIG. 2, but the data (44) is distributed to a server (40) after protection and saving. The data (44) also includes unprotected data (441) and protected data (442), where the protected data (442) includes license identifications (450) and encrypted data (460). Although not shown in FIG. 3, constraints can also be included in the protected data (442). The storage of licenses is also enforced to a token (30), where the token can be separated from the host. The token (30) includes license enforcements (32) and license storage (321), in addition to crypto means (34). The editor (12) and reader (18) do not have to be in the same client (10). In real life applications, there would typically be several client workstations (10) with associated license enforcement components (22 in FIG. 2, 32 in FIG. 3), and the editing process (12) would take place in one workstation, and the presentation process would take place in another workstation. FIG. 3 illustrates the chronological sequence of the data flow as number 1 to 4.

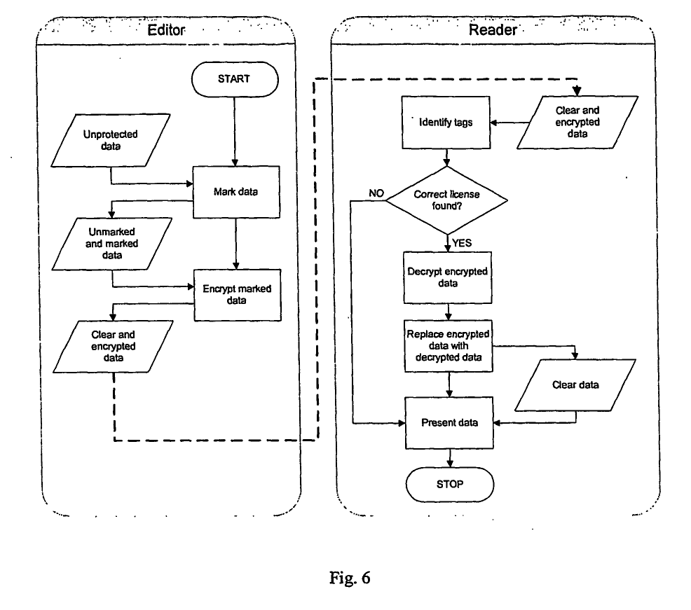

FIG. 6 shows a summary for the complete data flow for both the protection (preparation) and presentation phases.

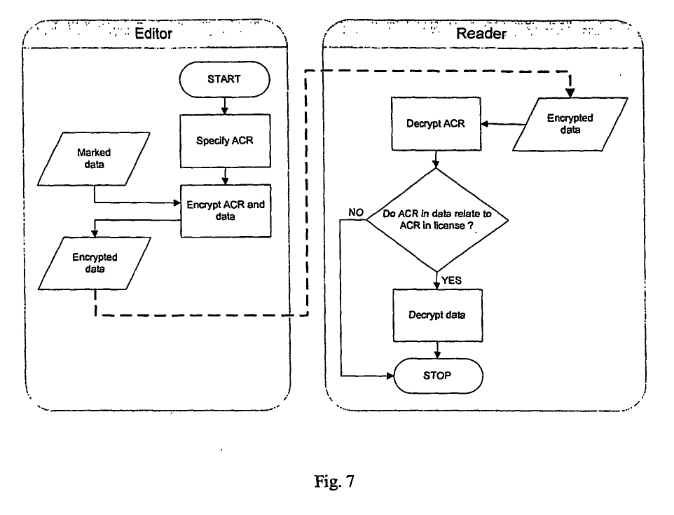

In a special case, access control rights (ACR) or other constraints are part of the encrypted data. In this case it is not enough to have a correct license identification and cryptographic information in the license, but the ACR or other constraints must also be correct. The constraints will typically be in the first part of the encrypted data and the rest of the data will only be decrypted if the license has correct constraints. It is possible to have constraints in both data and license (e.g., ACR which must be compared), just in license (e.g., in a case where the license can expire in time or be legal just a number of times) or in the data (e.g., in case where the encrypted data can expire in time). Other methods may exist as well. FIG. 7 is a high level flowchart of the ACR process.

### EXAMPLE USING HYPERTEXT MARKUP LANGUAGE (HTML)

Since the Internet is the most used network for information sharing and the World Wide Web is the most used interface to this sharing, the present example discusses the security filter as a filter between the Internet and a client browser.

In this example, a browser is used to access web pages. There are simple methods for obtaining web contents without using a browser. However, for clarity, the example presented herein is directed to a browser-based process. The scope of the present invention includes such non-browser methods of accessing web pages. In browser preference menus, a user has the opportunity to specify a filter.

The preparation phase of information that is to be shared on an Internet server consists of marking the information which requires special access rights and the encryption of these parts. A special case where this decision cannot be made is discussed at the end of this section. Referring to this example, the user decides which parts of the information to encrypt and what licenses to use. Since most web pages are constructed with hypertext markup language (html), this language will be used as an example. A web page is a continuous document consisting of html tags and ordinary text. The tags describe how the text will be presented in a browser. Some tags link to images and other web pages. The tags are only visible in a source code view in the browser and can be constructed as following:
<TAGNAME ‘tag options’> ‘text’ </TAGNAME>

Those familiar with html syntax will appreciate that this construction maps to most of the tags, but not all. An example can be the title of a page:
<TITLE>Web Filter</TITLE>

A special tag is the comment tag. Text inside the comment will not affect the presentation of a page in the normal browser view, and the comment tag does not require an ending tag. The construction of the comment tag is:
<!--This is a comment-->

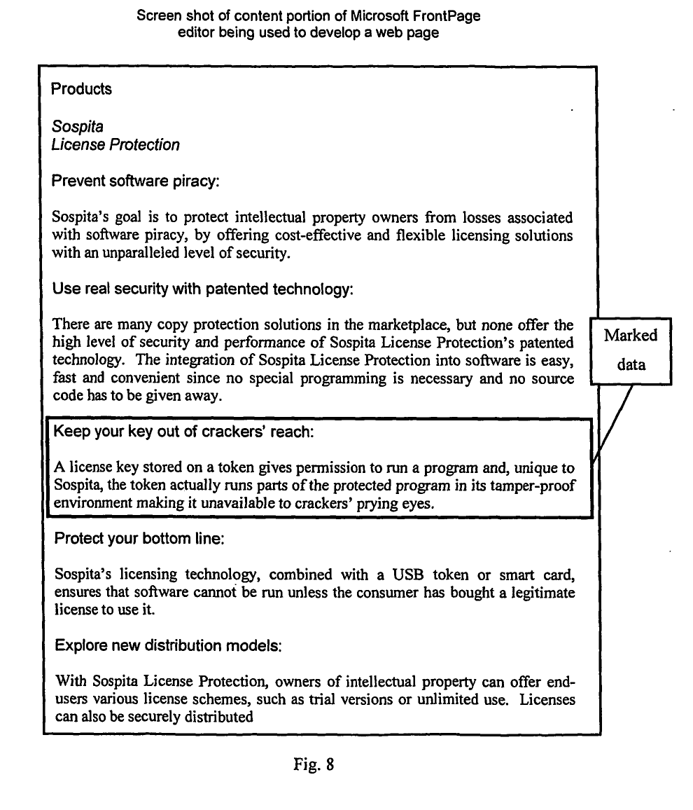

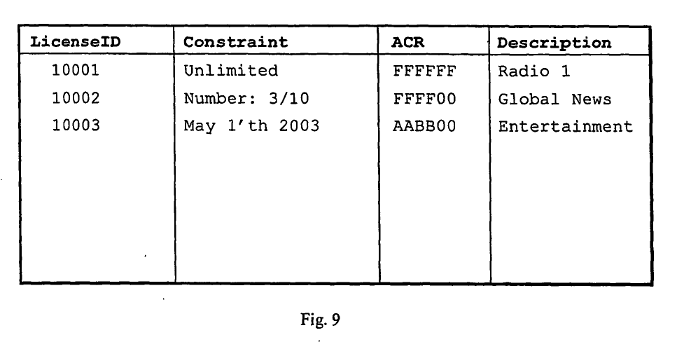

FIG. 8 shows the process of marking data in an editor, here, Microsoft FrontPage (only content portion is shown). In the example of FIG. 8, the data is part of text formatted in html and used as a web page. To generate a protected data element, the user marks the parts that will be encrypted. Then, the user activates an encryption functionality of the filter, such as by selecting an icon in a toolbar of the editor (not shown). When the user activates the filter, a new dialog box appears and lets the user choose a license resident on the token to be used for protection. FIG. 9 illustrates the dialog window, allowing the user a choice of different licenses. When a license is selected, the encryption of the selected parts takes place. For low bandwidth tokens, such as smart card based tokens, the encryption occurs by downloading cryptographic license information to the PC. For high bandwidth tokens, such as software tokens, the data can be streamed to the token and encrypted on the fly without any cryptographic license information leaving the token. The original data in the html document is erased and the encrypted data is then passed back into the document in comment tags. A shortened version of the protected data might look like this:
<!--Protected LicenseID=123 A16540F2E32 . . . -->

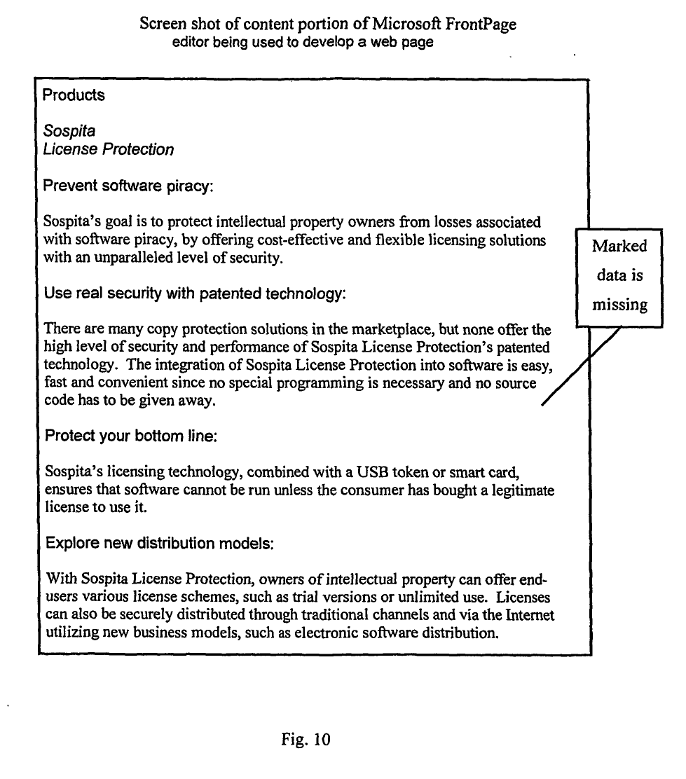

The encrypted data is coded from pure binary to a character set that is accepted by the hypertext transfer protocol. Two parameters are inserted into the comment. The first is an identification string, “Protected”, which indicates that this comment contains encrypted data, and the second string, “LicenseID=123”, refers to the license that was used in the protection. No cryptographic information about the license is included in the comment. Any constraints parameters will be part of the encrypted data, in addition to integrity control parameters like message digest or hash. FIG. 10 shows a protected web page. That is, FIG. 10 shows the same web page as in FIG. 8, but after protection is applied. Since html has syntax based comments, the protected parts do not show up in the editor.

When images are part of the protected data, new images are created along with encrypted linking to these images.

After this encryption and modification of the original html document, the document and any possible images can be uploaded to a public web server. There is no trust in this server, and all security of the contents of the html document lies in the strength of the cryptography. One suitable use of such a filter for processing web contents would be organizations that wish to hide their information for everyone but their trusted members. Even though administrators and agencies with legal rights for accessing the contents of such a site can obtain the data, it will not be in a readable form.

The other way of preparing encrypted documents is by selecting the data at source code level and then activating the license dialog box of the filter. The rest of the encryption and replacement of original data are the same as in the editor example.

A third preparation of encrypted data exists, but here the user does not have specific control of which parts to encrypt. This is by the use of forms in html documents. A form exists in a web page on a web server and can allow a viewer of the web page to insert text in text fields. These fields will have tags used for identification and further use of the entered data. As in the case of the manual protection, forms can contain tag names identifying that its content is going to be encrypted. A form having this functionality is given below:
<TEXTAREA NAME=“Protected 123” COLS=“60” ROWS=“4”></TEXTAREA>

In this case the text entered in the form will be encrypted when data is sent from the browser and through the filter. The filter will find the correct license, here, the license with “LicenseID=123”, from the license identification number provided in the form, and use the cryptographic information in this license to encrypt the data being sent. At the server side this data can be identified through the tag and used in dynamic web pages. The application areas for this scheme include simple guest books, sign-on, complex databases and others. Also, other forms may be constructed that allow user selection of licenses.

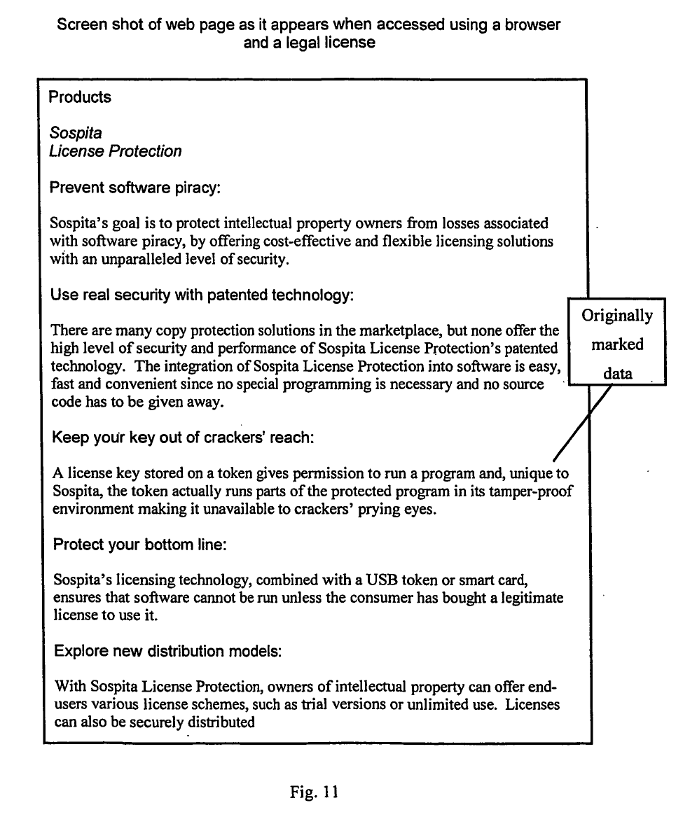

The viewing phase consists of the filter identifying the encrypted parts of a html document, searching for a license with the given license number, and if this license exist on the user's token, decrypting and presenting the data to the user as a normal document in the user's browser. FIG. 11 illustrates this process. When a correct license is found before the web page reaches the browser, then the protected data is decrypted and presented together with the rest of the data. There is no user interaction in this viewing process. If the user does not possess a license with the given license number, then the data remains encrypted and the user will only see the parts that are not encrypted in the browser. Unless the user examines the source code of the html document, the user is not able to tell if some parts of the code are protected or not. The exception is if the encryption is explicitly stated in the unencrypted text, or if the removal of the encrypted text gives an unnatural context in the html document.

Changes can be made to the embodiments described above without departing from the broad inventive concept thereof. The present invention is thus not limited to the particular embodiments disclosed, but is intended to cover modifications within the spirit and scope of the present invention.

What is claimed is:

1. A method of encrypting data which is originally unencrypted, the method comprising:
(a) selecting one or more portions of the unencrypted data to be encrypted;
(b) associating a license with the data portions to be encrypted, the license including license ID data and cryptographic information;
(c) protecting the data portions using cryptographic information of the associated license by
i) directly use the cryptographic information found in the license to encrypt the data portion selected, or
ii) encrypting the data portion selected with a user defined or random encryption key, encrypt this key with the cryptographic information found in the license, and include this encrypted key as a header to the encrypted data; and
(d) replacing each selected originally unencrypted data portion with its corresponding encrypted version of the data portion.

2. The method of claim 1 wherein the data are expressed by a programming language.

3. The method of claim 2 wherein the replaced data portions conform to the syntax of the programming language.

4. The method of claim 3 wherein the replaced data portions are included within a comment field of the programming language.

5. The method of claim 3 further comprising:
(e) including tags in the data to identify the license ID being used in the encryption in step (c), wherein the identifying tags of a license are included within the comment field of the programming language.

6. The method of claim 1 wherein the data are expressed by a syntax-based multimedia data format language.

7. The method of claim 6 wherein the replaced data portions conform to the syntax of the multimedia data format language.

8. The method of claim 7 wherein the replaced data portions are included within a comment field of the multimedia data format language.

9. The method of claim 7 wherein the replaced data portions are included within a header of the multimedia data format language.

10. The method of claim 7 further comprising:
(e) including tags in the data to identify the license ID being used in the encryption in step (c), wherein the identifying tags of a license are included within the comment field of the multimedia data format language.

11. The method of claim 1 wherein the data are expressed by a markup language.

12. The method of claim 11 wherein the replaced data portions are included within a comment field of the markup language.

13. The method of claim 12 further comprising:
(e) including tags in the data to identify the license ID being used in the encryption in step (c), wherein the identifying tags of a license are included within the comment field of the markup language.

14. The method of claim 11 wherein the replaced data portions conform to the syntax of the markup language.

15. The method of claim 1 further comprising:
(e) including tags in the data to identify the license ID being used in the encryption in step (c).

16. The method of claim 15 further comprising:
(f) storing the license data and cryptographic information in a token.

17. The method of claim 16 wherein the protection further includes access control rights, and step (f) further comprises storing the access control rights in the token.

18. The method of claim 16 wherein the license further includes a time constraint.

19. The method of claim 16 wherein the license further includes a number constraint.

20. The method of claim 1 wherein in step (a), at least a portion of the data is not selected for encryption so that after step (c) is completed, the data includes a combination of selected encrypted portions and unselected unencrypted portions.

21. The method of claim 20 further comprising:
(d) creating a rendition of the combination of the encrypted portions and the unencrypted portions.

22. The method of claim 1 wherein the portions of data to be selected in step (a) are manually selected by a user.

23. The method of claim 1 wherein the originally unencrypted data is presented on a user interface display, and the portions of data to be selected in step (a) are selected by highlighting the portions of data on the user interface display.

24. The method of claim 1 wherein the process is repeated with another license, giving a plurality of different encrypted data portions.

25. The method of claim 1 wherein the encrypted data is integrity protected by the use of an encrypted message digest.

26. The method of claim 1 wherein the license is a password-based encryption key.

27. A method for decrypting data that includes one or more portions of encrypted data, the method comprising:
(a) detecting the presence of an encrypted data portion within an original block of data;
(b) accessing license data from a license data memory; and
(c) using the license data obtained from the license data memory to determine if a valid license exists to receive a decrypted version of the encrypted data portion, and if so, then
(i-i) decrypting the encrypted data portion by directly using the cryptographic information of the associated license obtained from the license data memory, or
(i-ii) decrypting the cryptographic key in the header of the encrypted data using cryptographic information of the associated license obtained from the license data memory and decrypt the data portion by using the decrypted cryptographic key, and
(ii) replacing the encrypted data portion with a decrypted version of the data portion.

28. The method of claim 27 wherein step (c) further comprises:
(iii) presenting the decrypted version of the data portions to a display screen.

29. The method of claim 28 wherein the original block of data includes one or more unencrypted portions interspersed within the decrypted portion, and step (c)(iii) further comprises presenting the unencrypted portions and the decrypted portion to the display screen in a single, unified unencrypted manner.

30. The method of claim 29 wherein there are a plurality of different encrypted data portions, each having a unique license, and steps (a)-(c) are repeated for each of the different data portions, and step (c)(iii) further comprises presenting the unencrypted portions and the decrypted portions to the display screen in a single, unified unencrypted manner.

31. The method of claim 29 wherein if the user is determined not to hold a valid license to receive a decrypted version of the encrypted data portion, then step (c)(iii) further comprises presenting only the unencrypted data portions to the display screen in a rendition of the data.

32. The method of claim 27 wherein the data are expressed by a syntax-based multimedia data format language.

33. The method of claim 32 wherein the encrypted data portion conforms to the syntax of the multimedia data format language.

34. The method of claim 33 wherein the encrypted data portion is included within a comment field of the multimedia data format language.

35. The method of claim 32 wherein the encrypted data portion is included within a header of the multimedia data format language.

36. The method of claim 27 wherein the data are expressed by a markup language.

37. The method of claim 36 wherein the encrypted data portion conforms to the syntax of the markup language.

38. The method of claim 37 wherein the encrypted data portion is included within a comment field of the markup language.

39. The method of claim 27 wherein the data are expressed by a programming language.

40. The method of claim 39 wherein the encrypted data portion conforms to the syntax of the programming language.

41. The method of claim 40 wherein the encrypted data portion is included within a comment field of the programming language.

42. The method of claim 27 wherein the license is identified by tags in the data.

43. The method of claim 27 wherein the license data stored in the license data memory and the encrypted data include access control rights, and step (c) further comprises determining if the appropriate access control rights exist to receive a decrypted version of the encrypted data portion.

44. The method of claim 27 wherein the license data stored in the license data memory includes a time constraint, and step (c) further comprises determining if the time constraint is legal within the current time to receive a decrypted version of the encrypted data portion.

45. The method of claim 27 wherein the license data stored in the license data memory includes a number constraint, and step (c) further comprises determining if the number constraint is legal to receive a decrypted version of the encrypted data portion; and if so
(i) decrypt the data portion; and
(ii) decrease the number constraint

46. The method of claim 27 wherein there are a plurality of different encrypted data portions, each having a unique license, and steps (a)-(c) are repeated for each of the different data portions.

47. The method of claim 25 wherein the data is verified for correct integrity.

48. The method of claim 25 wherein the license data memory resides in a token, and step (b) further comprises accessing the license data and cryptographic information from the token.
